(19) United States
(12) Patent Application Publication
(10) Pub. No.: US 2025/0256602 A1
(43) Pub. Date: Aug. 14, 2025

(54) REINFORCED CONCRETE EMBEDDED WIRELESS CHARGING COILS

(71) Applicant: Toyota Motor Engineering & Manufacturing North America, Inc., Plano, TX (US)

(72) Inventors: Shailesh N. Joshi, Ann Arbor, MI (US); Yanghe Liu, Ann Arbor, MI (US); Ercan Mehmet Dede, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/437,747

(22) Filed: Feb. 9, 2024

(51) Int. Cl. B60L 53/38; B60L 53/12; E01C 11/18; H02J 50/00; H02J 50/10

(52) U.S. Cl. CPC B60L 53/38; B60L 53/12; E01C 11/18; H02J 50/005; H02J 50/10

(57) ABSTRACT

A wireless charging primary pad includes a transmitter coil formed from steel rebar and copper clad steel (CCS) wire, and a reinforced concrete slab with transmitter coil is embedded therein. The transmitter coil can be formed from the CCS wire wound around the steel rebar and/or the CCS wire extending from an end of the steel rebar. Also, the reinforced concrete slab can include a magnetizable concrete layer.

### TECHNICAL FIELD

The present disclosure relates generally to wireless charging coils, and particularly to wireless charging coils embedded in reinforced concrete.

### BACKGROUND

Charging an electric vehicle (EV) can be performed via “wireless” charging in which a transmitter coil (also known as a primary coil) and a receiver coil (also known as a secondary coil) are used to wirelessly transfer electrical power from a power station to the EV. The transmitter coil is disposed within a portable primary coil pad (also known simply as “portable primary pad”) that can be moved and placed in a desired position relative to an EV or within a permanent primary coil pad (also known simply as “permanent primary pad”) such as a concrete slab. The receiver coil is disposed or at least partially within the EV. And while the use of permanent primary pads can be desirable, the design and installation of transmitter coils in permanent primary pads can be cost prohibitive.

The present disclosure addresses issues related to permanent primary pads, and other issues related to wireless charging transmitter coils.

### SUMMARY

This section provides a general summary of the disclosure and is not a comprehensive disclosure of its full scope or all of its features.

In one form of the present disclosure, a wireless charging primary pad includes a transmitter coil formed from steel rebar and copper clad steel (CCS) wire, and a reinforced concrete slab. Also, the transmitter coil is embedded in the reinforced concrete slab.

In another form of the present disclosure, a wireless charging primary pad includes a transmitter coil formed from steel rebar and CCS wire, and a reinforced concrete slab with a concrete layer and a magnetizable concrete layer. Also, the transmitter coil is embedded in the reinforced concrete slab.

In still another form of the present disclosure, a wireless charging primary pad includes a transmitter coil formed from steel rebar and CCS wire, and a reinforced concrete slab with a concrete layer and a magnetizable concrete layer. Also, the transmitter coil is embedded in the concrete layer.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 shows a block diagram for a wireless charging system according to the teachings of the present disclosure;

FIG. 2 shows a perspective view of a primary pad according to the teachings of the present disclosure;

FIG. 3A shows a perspective view of section 3A in FIG. 2 according to one form of the present disclosure;

FIG. 3B shows perspective view of section 3B in FIG. 2 according to another form of the present disclosure;

FIG. 4A shows a perspective view of a copper clad steel (CCS) wire according to one variation of the present disclosure;

FIG. 4B shows a perspective view of a CCS wire according to another variation of the present disclosure;

FIG. 5A shows a side cross-sectional view of a transmitter coil embedded in a reinforced concrete slab according to one form of the present disclosure;

FIG. 5B shows a side cross-sectional view of a transmitter coil embedded in a reinforced concrete slab according to another form of the present disclosure;

FIG. 5C shows a side cross-sectional view of a transmitter coil embedded in a reinforced concrete slab according to still another form of the present disclosure;

FIG. 5D shows a side cross-sectional view of a transmitter coil embedded in a reinforced concrete slab according to yet another form of the present disclosure; and

FIG. 6 shows an electric vehicle during charging with a transmitter coil embedded in a reinforced concrete slab according to the teachings of the present disclosure.

### DETAILED DESCRIPTION

The present disclosure provides a vehicle wireless charging primary pad with a transmitter coil embedded in reinforced concrete. The reinforced concrete can be in the form of a reinforced concrete slab with rebar embedded therein and the transmitter coil is formed at least partially from copper clad steel (CCS) wire wound around the rebar and/or CCS wire extending from the rebar. Accordingly, the rebar is part of and/or assists in the formation of the transmitter coil. As used herein, the phrase “reinforced concrete” refers to a concrete structure in which rebar is embedded in the concrete such that the two materials (i.e., the concrete and the rebar) work or act together to resist external force applied to the concrete. Also, the term “rebar” as used herein refers to a reinforcing bar or rod used to enhance the tensile strength of concrete.

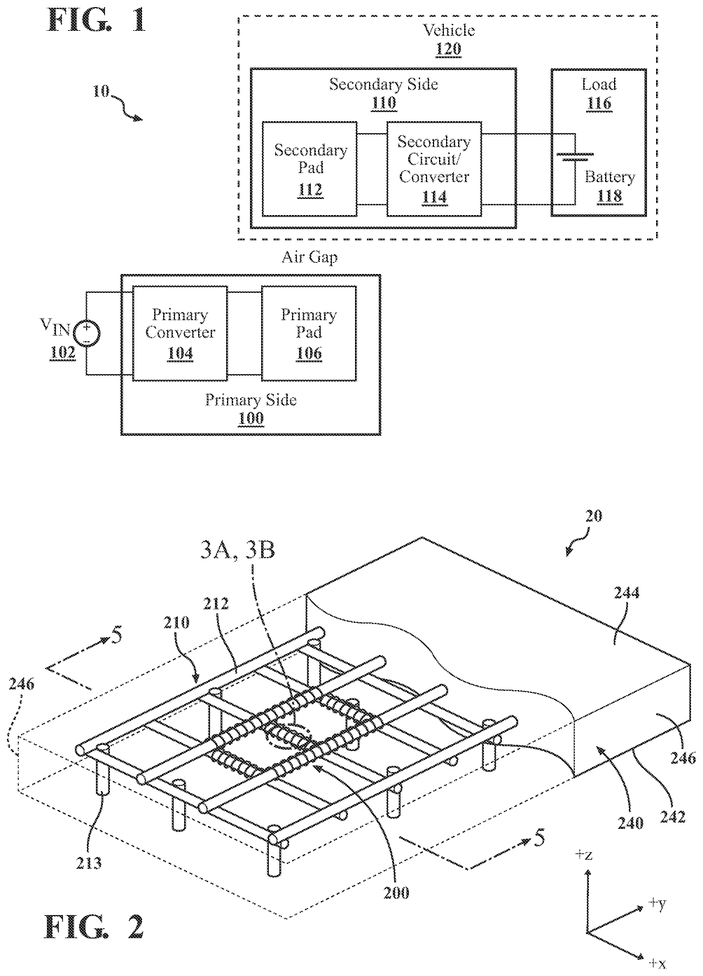

Referring to FIG. 1, a block diagram of a system 10 for wireless power transfer (“WPT”) is shown. The system 10 includes a primary side 100 with a voltage source 102, a primary converter 104, and a primary pad 106 with a transmitter coil (not shown). The voltage source 102 may be a utility power source, a generator, a battery, a solar panel system, etc. or any combination thereof.

The primary converter 104 receives electrical power, e.g., direct current (DC) electrical power or alternating current (AC) electrical power, from the voltage source 102 and provides AC power to the primary pad 106.

The system 10 also includes a secondary side 110 with a secondary pad 112 and a secondary converter 114. The secondary pad 112 includes a receiver coil (not shown) configured to wirelessly receive AC power from the transmitter coil of the primary pad 106 and the secondary converter 114 receives AC power from the secondary pad 112 and provides DC power to a load 116, e.g., a battery 118 or a motor (not shown), among others, of an electric vehicle (EV) 120. That is, the secondary side 110 is part of the EV 120. As used herein, the phrase “electric vehicle” refers to vehicle that uses electrical power for at least a portion of its propulsion (movement) force. Non-limiting examples of an EV include automobiles, trucks, boats, ships, off-road vehicles, airplanes, helicopters, and drones, among others.

In some variations, the primary pad 106 is embedded in a solid material for durability. For example, the primary pad 106 may be in a roadway, in a parking lot, or other location, and often must withstand forces caused by the EV 120 rolling over the primary pad 106. In some variations, the primary converter 104, or components of the primary converter 104, are also embedded in the solid material.

The primary pad 106 is configured to transmit the AC power wirelessly across a gap (e.g., an air gap) in a direction towards the secondary pad 112 as it is positioned, either statically or dynamically, proximate to the primary pad 106. The gap may include a portion of the solid material, a portion of material surrounding the secondary pad 112, and/or other materials, such as water.

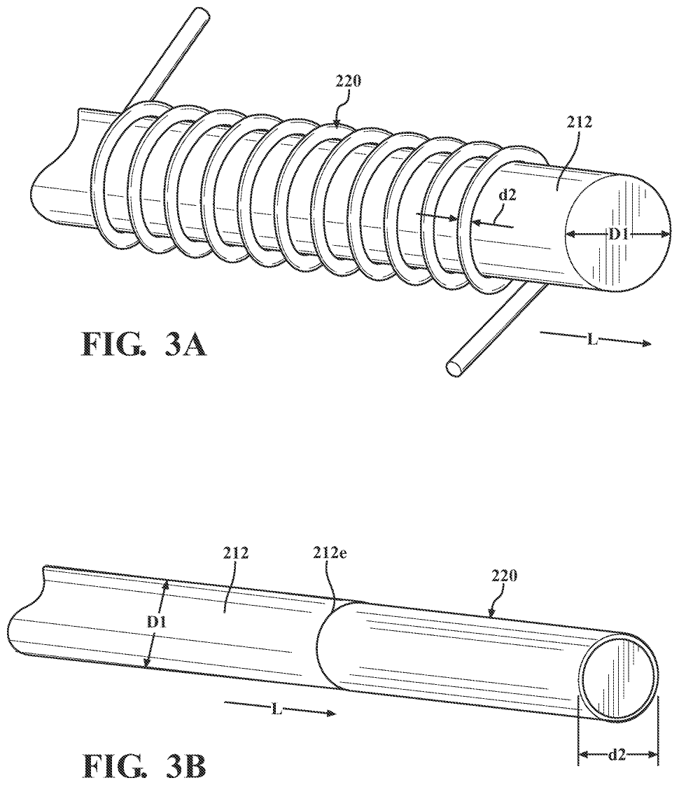

Referring to FIG. 2, a perspective cut-away view of a primary pad 20 according to the teachings of the present disclosure is shown. The primary pad 20 includes one or more transmitter coils 200 combined with a lattice or frame of rebar 210 (shown as smooth cylindrical rods for clarity) embedded in a reinforced concrete slab 240 with a lower (−z direction) surface 242 and an upper (+z direction) surface 244. The lattice of rebar 210 is formed from a plurality of rods of rebar 212 (also referred to herein simply as “rebar 212”) supported by or spaced apart from the lower surface 242 of the reinforced concrete slab 240 with a plurality of spacers 213. Accordingly, the lattice of rebar 210 is positioned at a desired location with respect to the upper surface 244 and a pair of side surfaces 246 of the reinforced concrete slab 240. In some variations, the rebar rods are steel rebar rods. And in at least one variation, the rods of rebar 212 are attached to each other, e g., tied or wired to each with rebar tie-wire, welded together, etc.

As observed from FIG. 2 and explained in more detail below, in some variations the lattice of rebar 210 assists in and/or is part of the transmitter coil 200. Accordingly, and in contrast to known primary pads that remove at least portions of steel rebar embedded in concrete in order to place or embed a transmitter coil, in some variations the primary pads according to the teachings of the present disclosure use steel rebar as part of the transmitter coil and thereby reduce the cost and complexity of primary pads for charging of EVs.

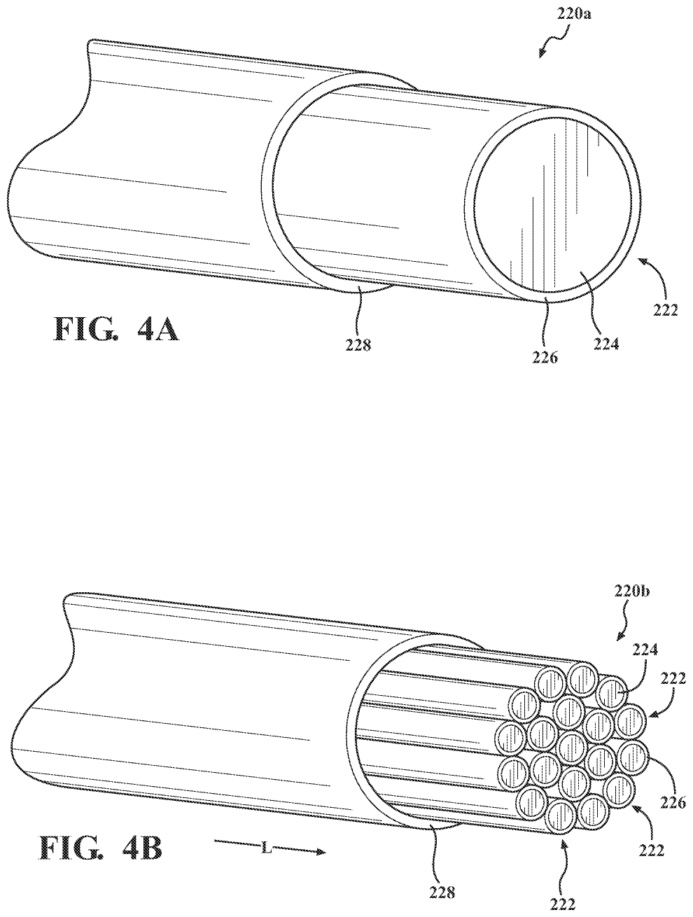

Referring to FIGS. 3A and 3B, enlarged views of section 3A, 3B in FIG. 2 are shown for two different transmitter coil 200 configurations. With reference to FIG. 3A, a portion of the transmitter coil 200 formed from wrapping the rebar 212 with CCS wire 220 is shown, i.e., the rebar 212 is wrapped or wound with the CCS wire 220 along a length direction L of the rebar 212. Also, the rebar 212 has a diameter “D1” and the CCS wire 220 has a diameter “d2” that is less than D1. Accordingly, in some variations the diameter of the CCS wire 220 used to form the transmitter coil 200 is less than the diameter of the rebar 212. And with reference to FIG. 3B, in at least one variation the rebar 212 has a diameter “D1”, the CCS wire 220 has a diameter “d2” that is about equal to D1, and the CCS wire 220 extends from an end 212e of the rebar 212.

Not being bound by theory, the configuration shown in FIG. 3A can be used for high power charging applications (i.e., power transfers between about 3.3 kilowatts (kW) and 11 KW) and the configuration shown in FIG. 3B can be used for low power charging applications (i.e., power transfers between about 1 kw and 3 KW). In addition the power transfer rate for the configuration shown in FIG. 3A is determined by “internal factors” and “external factors.” Non-limiting examples of internal factors include coil design and alignment factors such as the diameter d2 of the CCS wire 220, number of windings, density of routing, and alignment of coils, among others. And non-limiting examples of external factors include local area electrical grid power capacity, electromagnetic emission when using high power wireless energy transfer, local area standardization, materials of construction, and control, operation frequency, and communication technology available for a given wireless charging for power application, among others.

The diameter of the rebar 212 can be any diameter suitable for providing reinforcement to the reinforced concrete slab 240 and providing a desired diameter for the coil of CCS wire 220 on the rebar 212. Non-limiting examples of the size designation (#) of the rebar 212 and diameter D1 include #3-9.525 millimeters (mm) (0.375 inches (in.)), #4-12.7 mm (0.5 in.), #5-15.875 mm (0.625 in.), #6-19.05 mm (0.75 in.), #7-22.225 mm (0.875 in.), #8-25.4 mm (1.0 in.), #9-28.65 mm (1.128 in.), #10-32.26 mm (1.27 in.), #11-35.81 mm (1.41 in.), #14-43.0 mm (1.693 in.), and #18-57.22 mm (2.257 in.), among others.

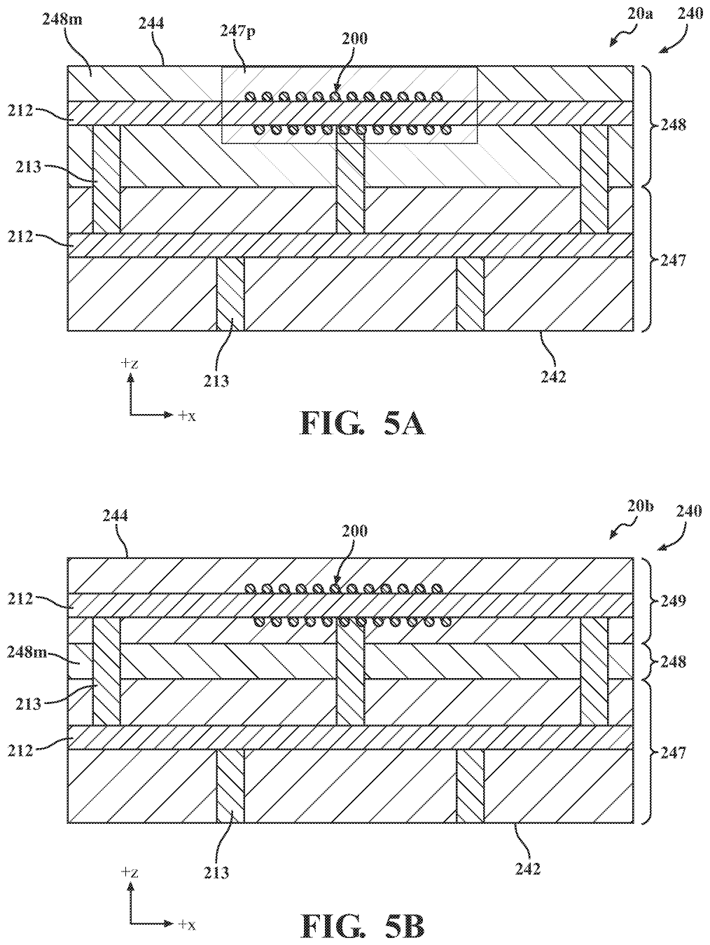

Referring to FIGS. 4A and 4B, in some variations, the CCS wire 220 is a single strand CCS wire 220a with a single wire 222 and an optional outer sleeve or coating 228 (e.g., a polymeric coating) or a multi-strand CCS wire 220b with a plurality of wires 222 with an optional outer sleeve or coating 228. With reference to FIG. 4A, the wire 222 is formed from a steel core 224 clad with copper 226. And with reference to FIG. 4B, each of the wires 222 include a steel core 224 clad with copper 226. And while FIG. 4B shows only steel cores 224 clad with copper 226, it should be understood that other wires that do not have a steel core 224 and/or are not clad with copper 226 can be included in the CCS wire 220b and the multi-strand CCS wire 220b can be a twisted structure, i.e., the wires 222 can be twisted into a predefined pattern along the length direction L.

The number and diameter d2 (FIG. 3B) of the single wires 222 that form a given CCS wire 220b can be any number and/or any diameter suitable for providing a desired power transfer from the transmitter coil 200 to a receiver coil. Non-limiting examples of the overall diameter and the d2 diameter for the CCS wire 220b include an overall diameter of 5.18 mm (0.20 in.) made from seven (7) wires 222 having a diameter of 1.73 mm (0.068 in.), an overall diameter of 6.55 mm (0.26 in.) made from seven wires 222 having a diameter of 2.18 mm (0.086 in.), an overall diameter of 7.76 mm (0.31 in.) made from seven wires 222 having a diameter of 2.59 mm (0.102 in.), an overall diameter of 8.72 mm (0.34 in.) made from seven wires 222 having a diameter of 2.91 mm (0.114 in.), an overall diameter of 9.79 mm (0.39 in.) made from seven wires 222 having a diameter of 3.26 mm (0.129 in.), an overall diameter of 10.51 mm (0.41 in.) made from seven wires 222 having a diameter of 3.50 mm (0.138 in.), an overall diameter of 11.00 mm (0.43 in.) made from seven wires 222 having a diameter of 3.67 mm (0.144 in.), an overall diameter of 12.34 mm (0.49 in.) made from seven wires 222 having a diameter of 4.11 mm (0.162 in.), an overall diameter of 13.86 mm (0.55 in.) made from seven wires 222 having a diameter of 4.62 mm (0.182 in.), and an overall diameter of 15.57 mm (0.61 in.) made from seven wires 222 having a diameter of 5.19 mm (0.204 in.), among others. Other non-limiting examples of the overall diameters and the d2 diameter for the CCS wire 220b include an overall diameter of 11.52 mm (0.45 in.) made from nineteen (19) wires 222 having a diameter of 2.3 mm (0.091 in.), an overall diameter of 12.94 mm (0.51 in.) made from nineteen wires 222 having a diameter of 2.59 mm (0.102 in.), an overall diameter of 14.40 mm (0.53 in.) made from nineteen wires 222 having a diameter of 2.68 mm (0.106 in.), an overall diameter of 14.53 mm (0.57 in.) made from nineteen wires 222 having a diameter of 2.91 mm (0.114 in.), an overall diameter of 16.32 mm (0.64 in.) made from nineteen wires 222 having a diameter of 3.26 mm (0.128 in.), an overall diameter of 18.33 mm (0.72 in.) made from nineteen wires 222 having a diameter of 3.67 mm (0.144 in.), an overall diameter of 20.57 mm (0.81 in.) made from nineteen wires 222 having a diameter of 4.11 mm (0.162 in.), an overall diameter of 23.10 mm (0.91 in.) made from nineteen wires 222 having a diameter of 4.62 mm (0.182 in.), and an overall diameter of 25.95 mm (1.02 in.) made from nineteen wires 222 having a diameter of 5.19 mm (0.204 in.), among others.

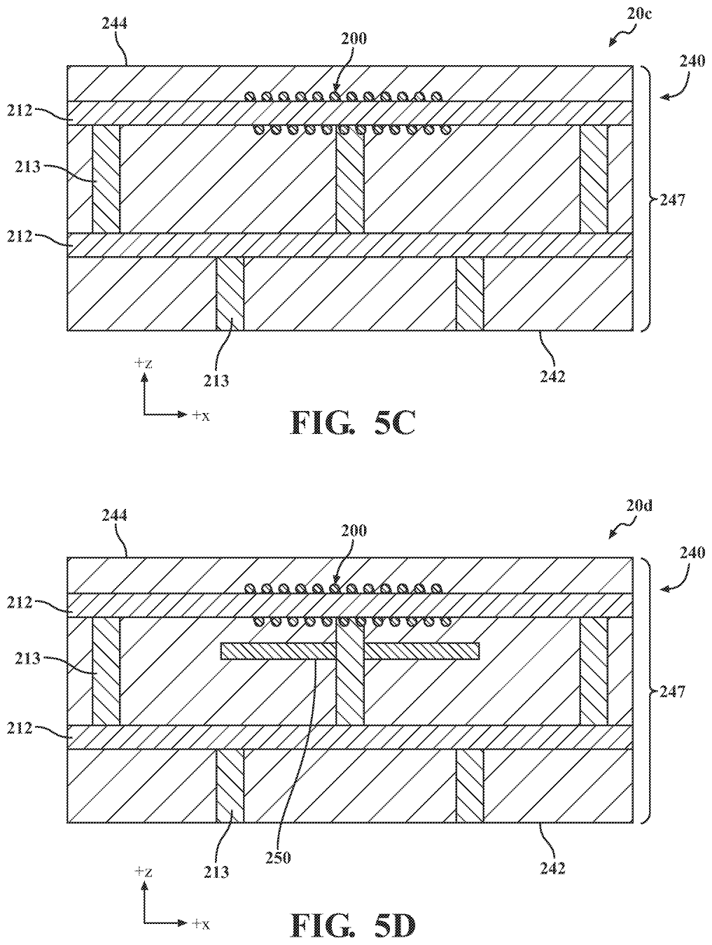

Referring to FIG. 5A, a cross-sectional view of section 5-5 in FIG. 2 according to one form of the present disclosure is shown. Particularly, a primary pad 20a includes a reinforced concrete slab 240 formed from a concrete layer 247 and a magnetizable concrete layer 248 with rebars 212 embedded therein. As used herein the term “concrete” refers to concrete without magnetic material mixed therein and the phrase “magnetizable concrete” refers to concrete with magnetic material mixed therein (i.e., magnetizable concrete 248m). The magnetizable concrete layer 248 is positioned outwardly from the concrete layer 247 and includes a concrete inset portion 247p in which the transmitter coil 200 is embedded. As used herein, the term “outwardly” refers to a position that is proximal to the upper surface 244 relative to the bottom surface 242 and distal from the bottom surface 242 relative to the upper surface 244.

The magnetizable concrete layer 248 below (−z direction) and beside (+/−x directions) the transmitter coil 200 reduces the “leakage” of the magnetic field between the transmitter coil 200 and a receiver (secondary) coil (not shown) in a secondary pad 112 of an EV 120 (FIG. 1). Stated differently, the magnetizable concrete layer 248 assists or enhances in directing a magnetic field generated by the transmitter coil 200 in a direction towards a secondary pad 112 of an EV 120 (+z direction shown in the figure). It should be understood that while the transmitter coil 200 shown in FIG. 5A is a high power transmitter coil 200 as discussed above with respect to FIG. 3A, a low power transmitter coil 200 as discussed above with respect to FIG. 3B can be embedded in the concrete inset portion 247p of the magnetizable concrete layer 248. And while FIG. 5A illustrates rebar 212 in the concrete layer 247, in some variations, the primary pad 20a does not include rebar 212 in the concrete layer 247, i.e., the rebar 212 is only embedded in the magnetizable concrete layer 248.

Referring to FIG. 5B, a cross-sectional view of section 5-5 in FIG. 2 according to another form of the present disclosure is shown. Particularly, a primary pad 20b includes a reinforced concrete slab 240 formed from a concrete layer 247, a magnetizable concrete layer 248, and another concrete layer 249. Rebar 212 is embedded in the concrete layers 247 and 249, and the transmitter coil 200 is embedded in the concrete layer 249 spaced apart from the magnetizable concrete layer 248. The magnetizable concrete layer 248 reduces the “leakage” of the magnetic field between the transmitter coil 200 and a receiver (secondary) coil (not shown) in a secondary pad 112 of an EV 120 (FIG. 1). Stated differently, the magnetizable concrete layer 248 assists in or enhances directing a magnetic field generated by the transmitter coil 200 in a direction towards a secondary pad 112 of an EV 120 (+z direction shown in the figure). It should be understood that while the transmitter coil 200 shown in FIG. 5B is a high power transmitter coil 200 as discussed above with respect to FIG. 3A, a low power transmitter coil 200 as discussed above with respect to FIG. 3B can be embedded in the magnetizable concrete layer 248. And while FIG. 5B illustrates rebar 212 in the concrete layer 247, in some variations, the primary pad 20a does not include rebar 212 in the concrete layer 247, i.e., the rebar 212 is only embedded in the concrete layer 249.

Referring to FIG. 5C, a cross-sectional view of section 5-5 in FIG. 2 according to still another form of the present disclosure is shown. Particularly, a primary pad 20c includes a reinforced concrete slab 240 formed from a single concrete layer 247 with rebar 212 and the transmitter coil 200 embedded therein. It should be understood that while the transmitter coil 200 shown in FIG. 5C is a high power transmitter coil 200 as discussed above with respect to FIG. 3A, a low power transmitter coil 200 as discussed above with respect to FIG. 3B can be embedded in the magnetizable concrete layer 248.

Referring to FIG. 5D, a cross-sectional view of section 5-5 in FIG. 2 according to yet another form of the present disclosure is shown. Particularly, a primary pad 20d includes a reinforced concrete slab 240 formed from a single concrete layer 247 with the transmitter coil 200, rebar 212, and a ferrite layer 250 embedded therein. The ferrite layer 250 reduces the “leakage” of the magnetic field between the transmitter coil 200 and a receiver (secondary) coil (not shown) in a secondary pad 112 of an EV 120 (FIG. 1). Stated differently, the ferrite layer 250 assists or enhances in directing a magnetic field generated by the transmitter coil 200 in a direction towards a secondary pad 112 of an EV 120 (+z direction shown in the figure). It should be understood that while the transmitter coil 200 shown in FIG. 5D is a high power transmitter coil 200 as discussed above with respect to FIG. 3A, a low power transmitter coil 200 as discussed above with respect to FIG. 3B can be embedded in the magnetizable concrete layer 248.

It should be understood that a primary pad 20 according to the teachings of the present disclosure can include a combination of the features shown and described in FIGS. 5A-5D. For example, a primary pad 20 can include the magnetizable concrete layer 248 illustrated in FIG. 5A or FIG. 5B in combination with the ferrite layer 250 illustrated in FIG. 5D. In addition, a primary pad 20 can include a reinforced concrete slab 240 formed from a single magnetizable concrete layer 248 with a concrete inset portion 247p where the transmission coil 200 is embedded.

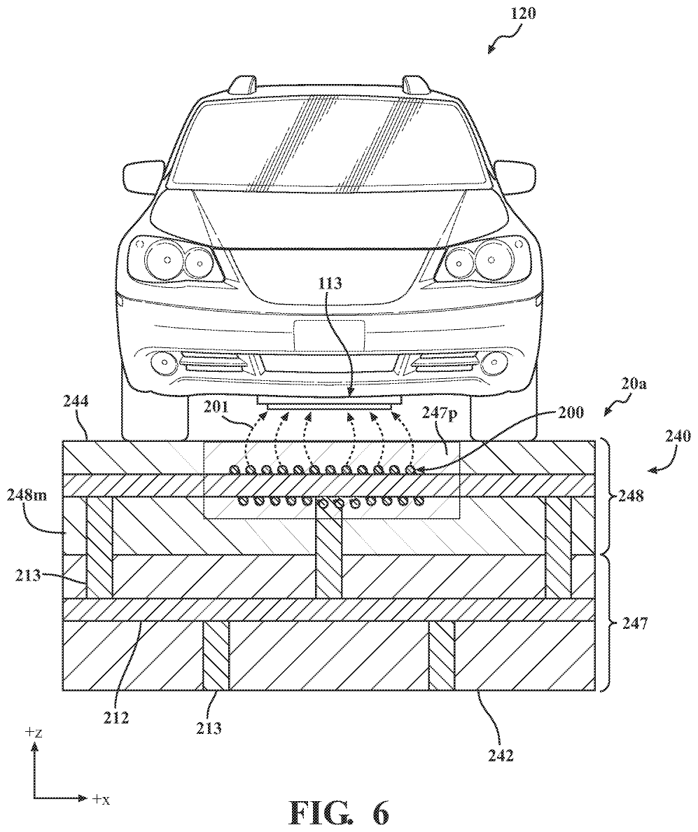

Referring to FIG. 6, in operation, an EV 120 (e.g., an automobile) is positioned above (+z direction) a primary pad 20 (primary pad 20a shown for illustrative purposes) and the transmitter coil 200 generates magnetic field 201 and transmits electrical power to a receiver coil 113 of the EV 120. In some variations, the EV 120 is stationary with respect to the transmitter coil 200, e.g., the EV 120 is parked over the transmitter coil 200 during charging such that static charging occurs, while in other variations, the EV 120 is not stationary with respect to the transmitter coil 200, e.g., the EV 120 drives over the transmitter coil 200 during charging such that dynamic charging occurs. And while FIG. 6 illustrates the receiver coil 113 and the transmitter coil arranged or oriented vertically (z-direction) with respect to each other, it should be understood that the receiver coil 113 and the transmitter coil 200 can be oriented horizontally (x-direction or y-direction) with respect to each other or at an orientation between vertical and horizontal. For example, in some variations the transmitter coil 200 can be embedded in a reinforced concrete slab 240 that is part of a wall or pillar of a parking structure such that the lattice of rebar 212 and the transmitter coil 200 extend along the x-z plane or y-z plane shown in the figures, and the upper surface 244 is proximal to the EV 120 relative to the lower surface 242. And in such variations the receiver coil can be located along a side panel of the EV 120.

It should be understood from the teachings of the present disclosure that a reinforced concrete primary pad for a wireless charging station is provided. The primary pad includes a transmitter coil formed from rebar wound with CCS wire and/or from CCS wire extending from an end of one or more rebar rods. In some variations, the reinforced concrete includes a layer of magnetizable concrete.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for conducting the methods described herein is suited. A typical combination of hardware and software can be a processing system with computer-usable program code that, when being loaded and executed, controls the processing system such that it conducts the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to conduct these methods.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation or particular system is included in at least one variation or form. The appearances of the phrase “in one variation” (or variations thereof) are not necessarily referring to the same variation or form. It should be also understood that the various method steps discussed herein do not have to be conducted in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A wireless charging primary pad comprising:
a transmitter coil comprising steel rebar and copper clad steel (CCS) wire; and
a reinforced concrete slab with the transmitter coil embedded therein.

2. The wireless charging primary pad according to claim 1, wherein the CCS wire has a diameter less than a diameter of the steel rebar.

3. The wireless charging primary pad according to claim 2, wherein the CCS wire is wound around the steel rebar.

4. The wireless charging primary pad according to claim 3, wherein the CCS wire is wound along a length direction of the steel rebar.

5. The wireless charging primary pad according to claim 1, wherein the CCS wire has a diameter about equal to a diameter of the steel rebar.

6. The wireless charging primary pad according to claim 5, wherein the CCS wire extends from an end of the steel rebar.

7. The wireless charging primary pad according to claim 1, wherein the reinforced concrete slab comprises magnetizable concrete.

8. The wireless charging primary pad according to claim 7 further comprising steel rebar without CCS wire embedded in the magnetizable concrete.

9. The wireless charging primary pad according to claim 1, wherein the reinforced concrete slab comprises a layer of concrete and a layer of magnetizable concrete with the transmitter coil embedded in the layer of concrete.

10. The wireless charging primary pad according to claim 9 further comprising steel rebar embedded in the layer of concrete.

11. The wireless charging primary pad according to claim 10 further comprising steel rebar embedded in the layer of magnetizable concrete.

12. The wireless charging primary pad according to claim 1, wherein;
the reinforced concrete slab comprises a layer of concrete, a layer of magnetizable concrete positioned outwardly from the layer of concrete, and a concrete inset portion within the layer of magnetizable concrete;
steel rebar is embedded in the layer of concrete; and
the transmitter coil is embedded in the concrete inset portion.

13. The wireless charging primary pad according to claim 12, wherein the CCS wire has a diameter less than a diameter of the steel rebar and the CCS wire is wound around a length direction of the steel rebar.

14. The wireless charging primary pad according to claim 12, wherein the CCS wire has a diameter about equal to a diameter of the steel rebar and the CCS wire extends from an end of the steel rebar.

15. A wireless charging primary pad comprising:
a transmitter coil comprising steel rebar and copper clad steel (CCS) wire; and
a reinforced concrete slab with a concrete layer, a magnetizable concrete layer, and the transmitter coil embedded in the reinforced concrete slab.

16. The wireless charging primary pad according to claim 15, wherein the transmitter coil is in the concrete layer.

17. The wireless charging primary pad according to claim 15, wherein the transmitter coil is embedded in the concrete layer outwardly from the magnetizable concrete layer.

18. The wireless charging primary pad according to claim 15, wherein the transmitter coil is selected from the group consisting of a high power transmitter coil with CCS wire having a diameter less than a diameter of the steel rebar and being wound around the steel rebar, and a low power transmitter coil with CCS wire having a diameter about equal to a diameter of the steel rebar and extending from an end of the steel rebar.

19. A wireless charging primary pad comprising:
a transmitter coil comprising steel rebar and copper clad steel (CCS) wire; and
a reinforced concrete slab with a concrete layer, a magnetizable concrete layer, and the transmitter coil embedded in the concrete layer.

20. The wireless charging primary pad according to claim 19, wherein the transmitter coil comprises the CCS wire wound around the steel rebar.
